(19) United States
(12) Patent Application Publication
(10) Pub. No.: US 2008/0019337 A1
(43) Pub. Date: Jan. 24, 2008

(54) Data transmission method and a base station

(75) Inventors: Esa Tiirola, Kempele (FI); Kari Horneman, Oulu (FI); Jyri K. Hamalainen, Oulu (FI); Kari Pajukoski, Oulu (FI); Seppo Vesterinen, Oulunsalo (FI)

Correspondence Address: Hollingsworth & Funk, LLC, Suite 125, 8009 34th Avenue South, Minneapolis, MN, 55425, US

(73) Assignee: Nokia Corporation

(21) Appl. No.: 11/522,601

(22) Filed: Sep. 18, 2006

(30) Foreign Application Priority Data
Jul. 18, 2006 (FI) 20065495

(51) Int. Cl. H04Q 7/24

(52) U.S. Cl. 370/338

(57) ABSTRACT

A data transmission method and a base station in a telecommunication system are provided. The base station comprises a first transmitter for transmitting a downlink packet transmission, a first receiver for receiving uplink packet transmission, a first controller for checking whether a packet is received successfully, thus obtaining a correct packet, a second receiver for receiving, from at least one other base station, a packet the at least one other base station has successfully received from the uplink direction, a second controller for combining a packet unsuccessfully received from the uplink direction with the at least one packet received from the at least one other base station, and a second transmitter, for sending a correct packet further to other parts of the telecommunication system.

### FIELD

The invention relates to a base station and a data transmission method in a telecommunication system comprising a plurality of base stations. In particular, the invention relates to implementing macro diversity in a telecommunication system.

### BACKGROUND

In many present telecommunication systems, radio resource management and traffic control are performed in a centralized manner. Radio resource management is responsible for controlling for example channel allocation and handovers in telecommunication systems. Traffic control management includes controlling macro diversity and retransmissions in connections utilising error correction methods, such as ARQ (Automatic Repeat-reQuest). In many present telecommunication systems such as Global System for Mobile telecommunication (GSM) and Universal Mobile Telecommunication System (UMTS) the infrastructure is such that several base stations are connected to a radio network controller (RNC) which takes care of the above mentioned radio resource management and traffic control.

Macro diversity is a procedure where a mobile station is in connection with more than one base station simultaneously. Macro diversity enables so-called soft handovers where a mobile terminal may gracefully switch from the service area of a base station to the service area of another base station. Typically, the borders of the service areas of adjacent base stations overlap and a mobile station may be in connection with several base stations at the same time. Uplink macro diversity is one key coverage-enhancing feature in future telecommunication systems. Macro diversity mitigates the detrimental effects of both shadowing and fast fading through selection and combining techniques. However, at the same time it increases the system complexity and load in the interface between base stations and a radio network controller. In GSM and UMTS, the interface between base stations and a radio network controller is called an Iub interface.

In present systems, the packets transmitted by a mobile station and received by more than one base station are combined in a radio network controller into one packet. The combination can be done either by soft combining or using selection combining. In soft combining, soft symbols from each packet are combined to improve the signal-to-noise ratio. In selection combining, the packet offering the best quality is selected as the packet to be transmitted further into the other parts of the system.

The drawback in both above options is that packets are sent through the Iub interface although they may be seriously corrupted. Base stations do not check the validity of the packets before sending them to the radio network controller. This generates overhead to the Iub interface. The radio network controller is responsible for checking the validity of the final packet and sending a retransmission request if a correct packet has not been obtained. Since the decision about the retransmission is made in the radio network controller, the delay in the process may be large.

It is predicted that the infrastructure of future telecommunication systems will be based on Internet Protocol (IP) networks. The nature of IP networks is that the control of the network is distributed among the network elements. Thus, there is no network element similar to a radio network controller, which manages the centralized control used in the current cellular networks. As macro diversity will also be an important feature in the future systems, the implementation of macro diversity without any additional delay and system complexity is essential.

### BRIEF DESCRIPTION OF THE INVENTION

An object of the invention is to provide a data transmission method which enables the use of macro diversity in networks employing distributed control. According to an aspect of the invention, there is provided a data transmission method in a telecommunication system comprising a plurality of base stations and at least one mobile station utilising a packet mode transmission, the method comprising, receiving, by the mobile station, the downlink packet transmission of a first base station, receiving, by the first base station and at least one other base station, the uplink packet transmission of the mobile station, checking, by the first base station and at least one other base station, whether a packet is received successfully from the mobile station, sending, by at least one other base station, a received packet to the first base station, if the at least one other base station received the packet successfully, and, if the first base station received a packet successfully from the mobile station, sending, by the first base station, a received packet further to other parts of the telecommunication system, and, if the first base station received a packet unsuccessfully from the mobile station, combining, by the first base station, the packet received from the mobile station with the at least one packet received from the at least one other base station, thus obtaining a combined packet and sending the combined packet further to other parts of the telecommunication system.

According to another aspect of the invention, there is provided a base station in a telecommunication system, comprising: a first transmitter for transmitting a downlink packet transmission, a first receiver for receiving uplink packet transmission, a first controller for checking whether a packet is received successfully, thus obtaining a correct packet, a second receiver for receiving, from at least one other base station, a packet the at least one other base station has successfully received from the uplink direction, a second controller for combining a packet unsuccessfully received from the uplink direction with the at least one packet received from the at least one other base station, and a second transmitter, for sending a correct packet further to other parts of the telecommunication system.

According to another aspect of the invention, there is provided a base station in a telecommunication system, comprising: means for transmitting a downlink packet transmission, means for receiving uplink packet transmission, means for checking whether a packet is received successfully, thus obtaining a correct packet, means for receiving, from at least one other base station, a packet the at least one other base station has successfully received from the uplink direction, means for combining a packet unsuccessfully received from the uplink direction with the at least one packet received from the at least one other base station, and means for sending a correct packet further to other parts of the telecommunication system.

According to another aspect of the invention, there is provided a base station in a telecommunication system, comprising: a first receiver for receiving uplink packet transmission, a first controller for checking whether a packet is received successfully, thus obtaining a correct packet, a second controller for checking if the received packet comprises an indicator that the packet is a retransmitted packet, and if this is the case, combining the retransmitted packet with a previously received packet, thus obtaining a combined packet, and checking whether the combined packet is a correct packet, a transmitter for sending a correct packet further to another base station.

According to another aspect of the invention, there is provided a base station in a telecommunication system, comprising: means for receiving uplink packet transmission, means for checking whether a packet is received successfully, thus obtaining a correct packet, means for checking if the received packet comprises an indicator that the packet is a retransmitted packet, and if this is the case, combining the retransmitted packet with a previously received packet, thus obtaining a combined packet, and checking whether the combined packet is a correct packet, and means for sending a correct packet further to another base station.

According to another aspect of the invention, there is provided a telecommunication system, comprising a plurality of base stations and at least one mobile station utilising a packet mode transmission, a first base station being configured to send downlink packet transmission to a mobile station, the first base station and at least one other base station being configured to receive uplink packet transmission of a mobile station and to check whether a packet is received successfully from the mobile station. The at least one other base station is configured to send a received packet to the first base station, if the at least one other base station received the packet successfully, and, if the first base station received a packet successfully from the mobile station, the first base station is configured to send a received packet further to other parts of the telecommunication system, and, if the first base station received a packet unsuccessfully from the mobile station, the first base station is configured to combine the packet received from the mobile station with the at least one packet received from the at least one other base station, thus obtaining a combined packet, and to send the combined packet further to other parts of the telecommunication system.

According to another aspect of the invention, there is provided a mobile station of a telecommunication system comprising a plurality of base stations, the mobile station configured to utilise a packet mode transmission; send a packet to at least one base station, and receive a retransmission request from a base station. The mobile station is configured to resend a packet on the basis of the retransmission request, the resent packet comprising an indication that the transmission is a retransmission.

According to another aspect of the invention, there is provided a mobile station of a telecommunication system comprising a plurality of base stations, the mobile station configured to utilise a packet mode transmission; send a packet to uplink direction, and receive a retransmission request from downlink direction. The mobile station is configured to resend a packet on the basis of the retransmission request, the resent packet comprising an indication that the transmission is a retransmission.

According to another aspect of the invention, there is provided a computer program distribution medium readable by a computer and encoding a computer program of instructions for executing a computer process for data transmission method in a telecommunication system, the process comprising: transmitting a downlink packet transmission, receiving uplink packet transmission, checking whether a packet is received successfully, thus obtaining a correct packet, receiving from at least one other base station, a packet the at least one other base station has successfully received from the uplink direction, combining a packet unsuccessfully received from the uplink direction with the at least one packet received from the at least one other base station, and sending a correct packet further to other parts of the telecommunication system.

The invention provides several advantages. In an embodiment of the invention, macro diversity may be implemented in a system lacking centralized control. Embodiments of the invention enable macro diversity connections in systems which do not have a Radio Network Controller or a respective network element. Furthermore, traffic load between base stations is reduced.

### LIST OF DRAWINGS

In the following, the invention will be described in greater detail with reference to the embodiments and the accompanying drawings, in which

FIGS. 1 and 2 show an example of a telecommunication system;

FIGS. 3A and 3B illustrate an embodiment of the invention with flowcharts;

FIGS. 4A and 4B illustrate another embodiment of the invention with flowcharts;

FIG. 5 illustrates another embodiment of the invention with a flowchart;

FIG. 6A illustrates an example of the structure of a downlink serving base station DLS-BS; and

FIG. 6B illustrates an example of the structure of an uplink serving base station ULS-BS.

### DESCRIPTION OF EMBODIMENTS

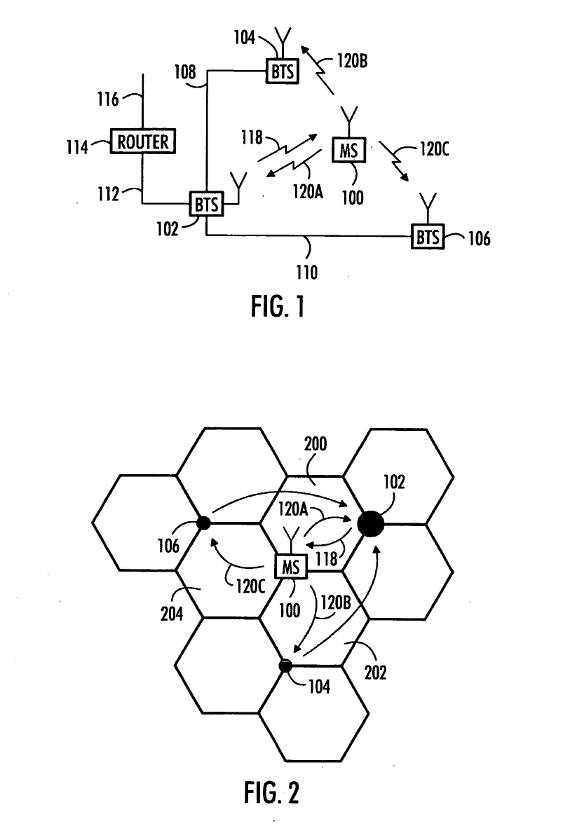

FIGS. 1 and 2 illustrate an example of a telecommunication system in which embodiments of the invention can be applied. FIG. 1 shows a mobile station (MS) 100 and a part of the radio access network of the telecommunications network, namely three base stations (BTS) 102, 104, 106. The base stations 104, 106 are connected 108, 110 to the base station 102. The base station 102 is connected 112 to a router 114, which in turn is connected 116 to other parts of the telecommunication network, such as a core network or other parts of radio access network. Also the base stations 112, 114 may be directly connected to a router, but these connections are not shown in FIG. 1.

FIG. 2 illustrates the network in a more visual manner. The base station 102 serves a coverage area 200. The mobile station 100 is in the coverage area 200 and served by the base station 102. The base station 102 is transmitting a downlink packet transmission 118 to the mobile station 100. The mobile station 100 is transmitting uplink packet transmission 120A to the base station 102. As the mobile station is near the border of the coverage area 200, the transmission of the mobile station 120B, 120C is also received by nearby base stations 104, 106, which are serving nearby coverage areas 202, 204. However, the base stations 104, 106 are not transmitting to the mobile station 100. Thus, the example of FIGS. 1 and 2 describes an uplink macro diversity situation.

In the example of FIGS. 1 and 2 there is no Radio Network Controller between base stations and the rest of the network. In current implementations of macro diversity, the control and combining of macro diversity connections is done in the Radio Network Controller. The example presented in FIGS. 1 and 2 discloses a solution where the base station 102 acts as a master base station or a downlink serving base station (DLS-BS). The other base stations 104, 106 act as slave base stations or uplink serving base stations (ULS-BS). The downlink serving base station (DLS-BS) receives the downlink data intended for the mobile station from the serving router 114 and is responsible for downlink data transfer (from BTS to MS). The uplink transfer from the mobile station may go through the downlink serving base station and additionally one or more uplink serving base stations either to the downlink serving base station or directly to the serving router.

In the embodiment of FIGS. 1 and 2, the base station 102 acts as the DLS-BS and the other base stations 104, 106 act as the ULS-BS. The uplink transmissions received by the ULS-BS are transmitted via connections 108 and 110 to the ULS-BS which is responsible for the macro combining. The combined uplink signal is transmitted to the router 114 via the connection 112. As the downlink traffic is handled by the DLS-BS, the DLS-BS is also responsible for retransmission control related to error correction methods, such as ARQ (Automatic Repeat-reQuest) or HARQ (Hybrid Automatic Repeat-reQuest). There are different methods to arrange HARQ, such as chase combining or incremental redundancy, as one skilled in the art is aware. These methods may be utilised in connection with the embodiments of the invention.

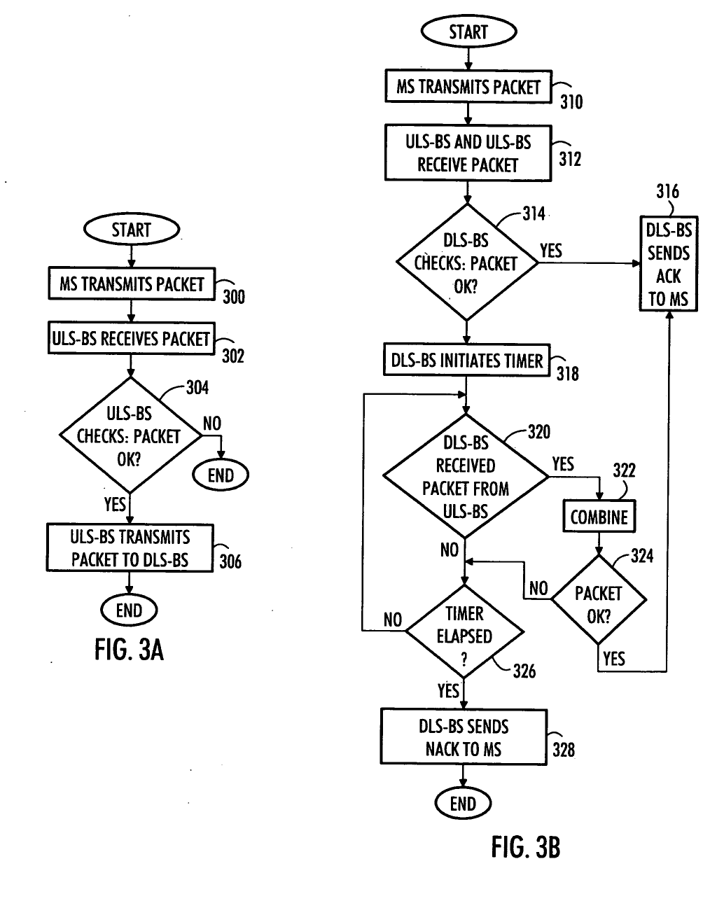

FIGS. 3A and 3B illustrate an embodiment of the invention with flowcharts. FIG. 3A illustrates an embodiment of the invention with a flowchart from the ULS-BS point of view. In step 300, a mobile station transmits a packet. In step 302, the uplink serving base station ULS-BS receives the packet.

In step 304, the uplink serving base station ULS-BS checks whether the packet is received successfully from the mobile station. The checking of the successfulness of the reception may be performed using known methods.

If the reception has not been successful, the process ends. Thus, in the case of unsuccessful reception, the uplink serving base station ULS-BS does not send anything to the downlink serving base station DLS-BS. The load of the interface between base stations is reduced compared to the prior art solutions.

If the reception has been successful, the uplink serving base station ULS-BS sends 306 the packet to the downlink serving base station DLS-BS.

The flowchart of FIG. 3B describes an embodiment from the DLS-BS point of view. In step 310, a mobile station transmits a packet. In step 312, the downlink serving base station DLS-BS receives the packet.

In step 314, the downlink serving base station DLS-BS checks whether the packet is received successfully from the mobile station. The checking of the successfulness of the reception may be performed using known methods.

If the reception has been successful, the downlink serving base station DLS-BS may send 316 a positive acknowledgement (ACK) message to the mobile station.

If the reception has not been successful, the downlink serving base station DLS-BS may store the received erroneous packet and initiate 318 a timer for measuring time elapsed since the unsuccessful reception of a packet.

In step 320, the downlink serving base station DLS-BS checks whether any uplink serving base station ULS-BS has sent a packet which ULS-BS had received from the mobile station. If a packet has not been received, the downlink serving base station DLS-BS checks in step 326 whether a predetermined time has elapsed since initiating the timer.

If the timer has not elapsed, the process continues from step 320 where the downlink serving base station DLS-BS checks whether any uplink serving base station ULS-BS has sent a packet.

If a predetermined time has elapsed since initiating the timer, the downlink serving base station DLS-BS sends 328 a negative acknowledgement (NACK) message to the mobile station.

If a packet has been received in step 320, then in an embodiment the packet received from the ULS-BS is combined 322 with the corrupted packet the DLS-BS received. In an embodiment, such combining is not performed and the packet received from the ULB-BS is taken forward alone. The packets may comprise identification or numbering so that correct packets are combined.

In step 324, the downlink serving base station DLS-BS checks whether the packet is correct. If this is the case, the process continues from 316 by the DLS-BS sending a positive acknowledgement (ACK) message to the mobile station.

If the packet is not correct, the process continues from step 326 as described above.

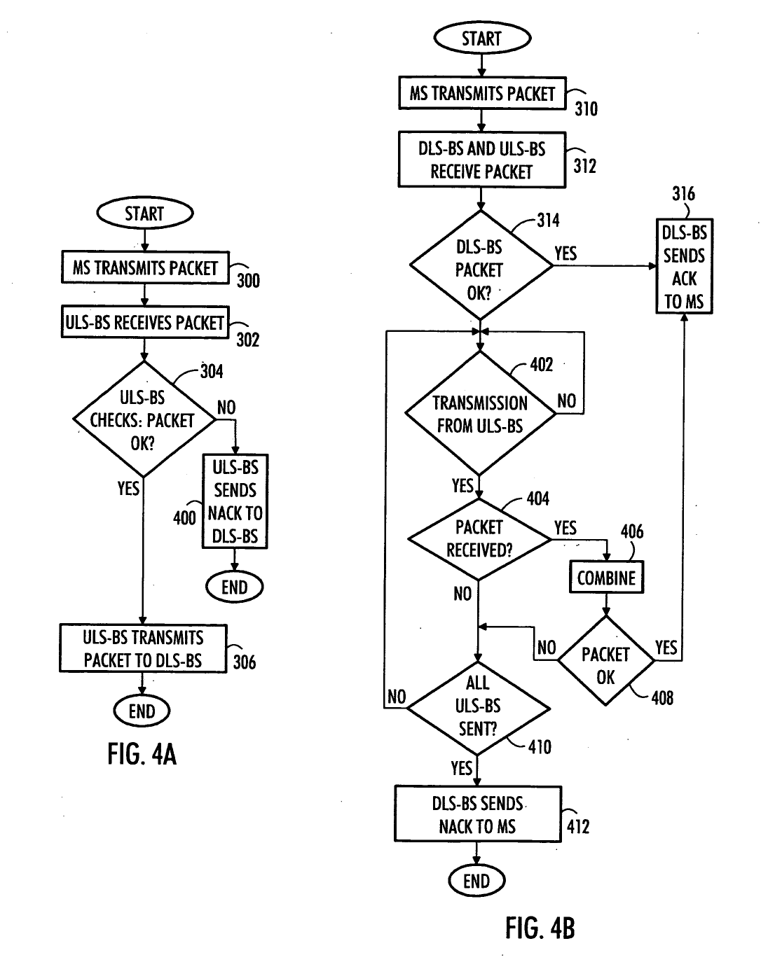

FIGS. 4A and 4B illustrate another embodiment of the invention with flowcharts. In this embodiment, a timer is not needed at the downlink serving base station DLS-BS. FIG. 4A illustrates an embodiment of the invention with a flowchart from the ULS-BS point of view. The embodiment is similar to the embodiment described in connection with FIG. 3A regarding steps 300 to 304. There is, however, a difference after the step 304. In step 304, the uplink serving base station ULS-BS checks whether the packet is received successfully from the mobile station. In this embodiment, if a packet has been received unsuccessfully, the uplink serving base station ULS-BS sends 400 a negative acknowledgement (NACK) message to the downlink serving base station DLS-BS. If the reception has been successful, the uplink serving base station ULS-BS sends 306 the packet to the downlink serving base station DLS-BS.

The flowchart of FIG. 4B describes an embodiment from the DLS-BS point of view. The embodiment is similar to the embodiment described in connection with FIG. 3B regarding steps 310 to 314. There is, however, a difference after the step 314. In step 314, the downlink serving base station DLS-BS checks whether the packet is received successfully from the mobile station. The checking of the successfulness of the reception may be performed using known methods.

If the reception has been successful, the downlink serving base station DLS-BS may send 316 a positive acknowledgement (ACK) message to the mobile station.

If the reception has not been successful, the downlink serving base station DLS-BS waits in step 402 until it receives a transmission from an uplink serving base station ULS-BS.

When a transmission is received, the downlink serving base station DLS-BS checks in step 404 whether a packet or a NACK has been received from an uplink serving base station.

If a NACK has been received, the process continues from step 410 explained below.

If a packet has been received, then in an embodiment the packet received from the ULS-BS may be combined in step 406 with the corrupted packet the DLS-BS received. In an embodiment, such combining is not performed and the packet received from the ULB-BS is taken forward alone.

In step 408, the downlink serving base station DLS-BS checks whether the packet is correct. If this is the case, the process continues from 316 by the DLS-BS sending a positive acknowledgement (ACK) message to the mobile station.

If the packet is not correct, the process continues from step 410.

In step 410, the downlink serving base station DLS-BS checks whether all uplink serving base stations ULS-BS have sent a transmission. If this is the case, the downlink serving base station DLS-BS sends 412 a negative acknowledgement (NACK) message to the mobile station.

If all uplink serving base stations ULS-BS have not yet sent something, the process continues from 402.

As in this embodiment, the uplink serving base stations ULS-BS send a transmission regardless of whether they have successfully received a packet, the downlink serving base station DLS-BS does not need a timer. From the transmissions of the uplink serving base stations ULS-BS the DLS-BS may determine whether any ULS-BS has received a packet. However, the traffic in the interface between the ULS-BS and the DLS-BS is increased compared to the embodiment of FIGS. 3A and 3B.

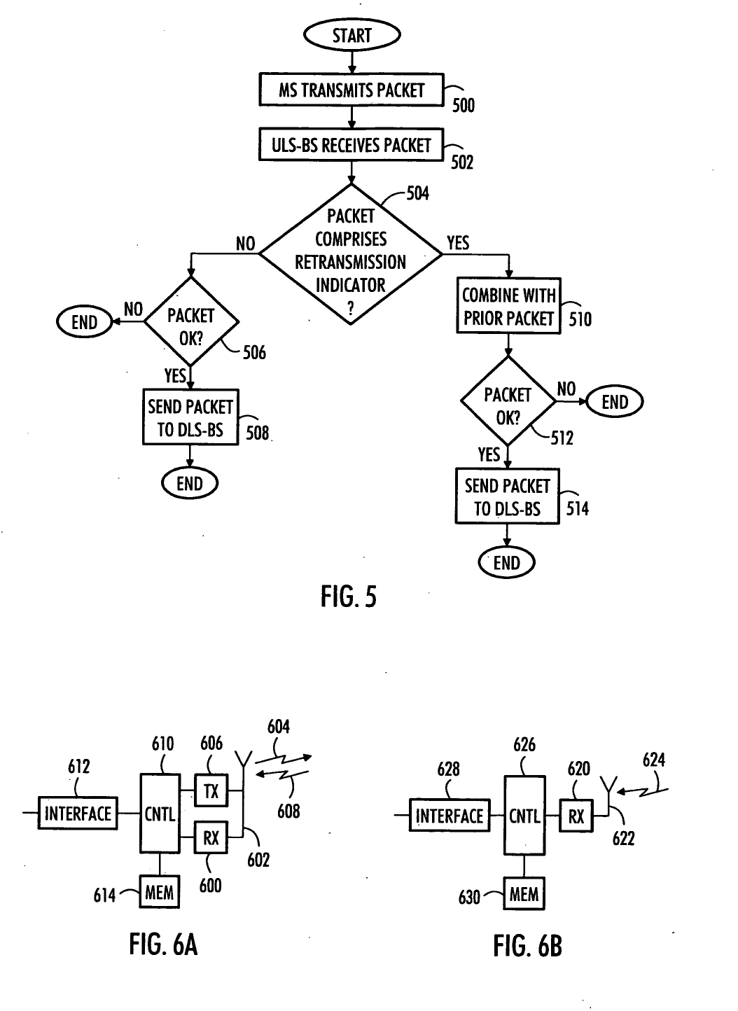

FIG. 5 illustrates an embodiment of the invention with a flowchart. In this embodiment, when a mobile station receives a retransmission request from the downlink serving base station DLS-BS, the mobile station attaches retransmission indicator to the packet to be resent. The retransmission indicator indicates that the packet is a retransmitted packet. The retransmission indicator aids the uplink serving base stations ULS-BS to notice that a transmission received from the mobile station is a retransmission, as the ULS-BS have no knowledge regarding the transmission of retransmission requests.

FIG. 5 illustrates this embodiment of the invention from the ULS-BS point of view. In step 500, a mobile station transmits a packet. In step 502, the uplink serving base station ULS-BS receives the packet.

In step 504, the uplink serving base station ULS-BS checks whether the packet comprises a retransmission indicator. If an indicator is not found, the transmission is not a retransmission. In such a case, the uplink serving base station ULS-BS checks in step 506, whether the packet is received successfully from the mobile station. The checking of the successfulness of the reception may be performed using known methods.

If the reception has been successful, the uplink serving base station ULS-BS sends 508 the packet to the downlink serving base station DLS-BS.

If the reception has not been successful, process ends. Thus, in the case of unsuccessful reception the uplink serving base station ULS-BS does not send anything. In an embodiment, the uplink serving base station ULS-BS may send a NACK to the downlink serving base station DLS-BS.

If an indicator is found in step 504, the transmission is a retransmission. In such a case, the uplink serving base station ULS-BS combines the received packet with a previously received packet in step 510.

The uplink serving base station ULS-BS checks in step 512, whether the combined packet is correct. The checking of the successfulness of the reception may be performed using known methods.

If the packet is correct, the uplink serving base station ULS-BS sends 514 the packet to the downlink serving base station DLS-BS.

If the packet is not correct, the process ends or the uplink serving base station ULS-BS sends a NACK to the downlink serving base station DLS-BS, depending on the embodiment.

With reference to FIG. 6A, examine an example of the structure of the downlink serving base station DLS-BS in which embodiments of the invention can be applied. The base station comprises a first transmitter 600 for transmitting using an antenna 602 a downlink packet transmission 604 to a mobile station of the telecommunication system (not shown). The base station further comprises a first receiver 606 for receiving using the antenna 602 uplink packet transmission 608 from a mobile station and a controller 610 operationally connected to the first transmitter 600 and the first receiver 606 for checking whether a packet is received successfully from the mobile station, thus obtaining a correct packet.

The base station further comprises an interface 612 connected to the controller 610 and configured to receive, from at least one other base station, a packet the at least one other base station has successfully received from the mobile station. The controller 610 is further configured to combine a packet unsuccessfully received from the mobile station with the at least one packet received from the at least one other base station. The interface 612 is configured to send a correct packet further to other parts of the telecommunication system. The interface 612 may comprise a transmitter and a receiver for transmitting and receiving information. The controller 610 may comprise one or more separate controllers realised with general or signal processors, separate logic circuits and associated software.

The base station may further comprise a memory unit 614 operationally connected to the controller 610 for storing data, such as received packets, for example.

With reference to FIG. 6B, examine an example of the structure of the uplink serving base station ULS-BS in which embodiments of the invention can be applied. The base station comprises a first receiver 620 for receiving using an antenna 622 uplink packet transmission 624 from a mobile station and a controller 626 operationally connected to the first receiver 620 for checking whether a packet is received successfully from the mobile station (not shown), thus obtaining a correct packet. The controller 626 is further configured to check if the received packet comprises an indication that the packet is a retransmitted packet, and if this is the case, combine the retransmitted packet with a previously received packet, thus obtaining a combined packet. The controller 626 is further configured to check whether the combined packet is a correct packet. The base station further comprises an interface or a transmitter 628 for sending a correct packet further to another base station. The controller 626 may comprise one or more separate controllers realised with general or signal processors, separate logic circuits and associated software. The base station may further comprise a memory unit 630 connected to the controller 626 for storing data, such as received packets, for example.

In practice, the structure of the uplink serving base station ULS-BS may be similar to the downlink serving base station DLS-BS, as each base station may act as a DLS-BS to a mobile station and ULS-BS to another mobile station, depending on the location of the mobile stations.

In an embodiment, a mobile station retransmitting a packet, adds an indicator to the packet to be retransmitted. The indicator indicates to a receiving base station that the packet is a retransmitted packet. This feature may be realised in a mobile station typically by programming and/or software.

The controller of a base station in which embodiments of the invention can be applied may be configured to perform at least some of the steps described in connection with the flowcharts of FIGS. 3A, 3B, 4A, 4B and 5. The embodiments may be implemented as a computer program comprising instructions for executing a computer process for data transmission method in a telecommunication system, the process comprising: transmitting a downlink packet transmission to a mobile station of the telecommunication system; receiving uplink packet transmission from the mobile station; checking whether a packet is received successfully from the mobile station, thus obtaining a correct packet; receiving, from at least one other base station, a packet the at least one other base station has successfully received from the mobile station; combining a packet unsuccessfully received from the mobile station with the at least one packet received from the at least one other base station; and sending a correct packet further to other parts of the telecommunication system.

The computer program may be stored on a computer program distribution medium readable by a computer or a processor. The computer program medium may be, for example but not limited to, an electric, magnetic, optical, infrared or semiconductor system, device or transmission medium. The medium may include at least one of the following media: a computer readable medium, a program storage medium, a record medium, a computer readable memory, a random access memory, an erasable programmable read-only memory, a computer readable software distribution package, a computer readable signal, a computer readable telecommunications signal, computer readable printed matter, and a computer readable compressed software package.

Even though the invention has been described above with reference to an example according to the accompanying drawings, it is clear that the invention is not restricted thereto but it can be modified in several ways within the scope of the appended claims.

1. A data transmission method in a telecommunication system comprising a plurality of base stations and at least one mobile station utilising a packet mode transmission, the method comprising,
receiving, by the mobile station, the downlink packet transmission of a first base station,
receiving, by the first base station and at least one other base station, the uplink packet transmission of the mobile station,
checking, by the first base station and at least one other base station, whether a packet is received successfully from the mobile station,
sending, by at least one other base station, a received packet to the first base station, if the at least one other base station received the packet successfully,
and, if the first base station received a packet successfully from the mobile station, sending, by the first base station, a received packet further to other parts of the telecommunication system,
and, if the first base station received a packet unsuccessfully from the mobile station, combining, by the first base station, the packet received from the mobile station with the at least one packet received from the at least one other base station, thus obtaining a combined packet and sending the combined packet further to other parts of the telecommunication system.

2. The method of claim 1, further comprising sending by the at least one other base station a message to the first base station when a packet has been received from the mobile station unsuccessfully.

3. The method of claim 1, further comprising sending by the first base station a retransmission request to the mobile station if both the first base station and the at least one other base station received a packet unsuccessfully.

4. The method of claim 1, the further comprising:
initialising a timer by the first base station when a packet is received unsuccessfully from the mobile station,
sending by the first base station a retransmission request to the mobile station if a successfully received packet has not been received from at least one other base station within a predetermined time period.

5. The method of claim 3, further comprising resending by the mobile station a packet on the basis of the retransmission request, the resent packet comprising retransmission indicator for indicating that the transmission is a retransmission.

6. The method of claim 3, further comprising receiving by the at least one other base station the retransmitted packet,
detecting by the at least one other base station from the retransmission indicator of the packet that the packet is a retransmitted packet,
combining by the at least one other base station the retransmitted packet with a previously received packet,
checking by the at least one other base station if the combined packet is correct and sending the combined packet to the first base station if the combined packet is correct.

7. A base station in a telecommunication system, comprising:
a first transmitter for transmitting a downlink packet transmission,
a first receiver for receiving uplink packet transmission,
a first controller for checking whether a packet is received successfully, thus obtaining a correct packet,
a second receiver for receiving, from at least one other base station, a packet the at least one other base station has successfully received from the uplink direction,
a second controller for combining a packet unsuccessfully received from the uplink direction with the at least one packet received from the at least one other base station, and
a second transmitter, for sending a correct packet further to other parts of the telecommunication system.

8. The base station of claim 7, further comprising a third controller for initialising a timer when a packet is received unsuccessfully from the uplink direction, and
sending a retransmission request to the downlink direction if a successfully received packet has not been received from at least one other base station within a predetermined time period.

9. The base station of claim 7, further comprising a third controller configured to send a retransmission request to the downlink direction if a correct packet has not been received from the uplink direction or from the at least one other base station.

10. A base station in a telecommunication system, comprising:
means for transmitting a downlink packet transmission,
means for receiving uplink packet transmission,
means for checking whether a packet is received successfully, thus obtaining a correct packet,
means for receiving, from at least one other base station, a packet the at least one other base station has successfully received from the uplink direction,
means for combining a packet unsuccessfully received from the uplink direction with the at least one packet received from the at least one other base station, and
means for sending a correct packet further to other parts of the telecommunication system.

11. A base station in a telecommunication system, comprising:
a first receiver for receiving uplink packet transmission,
a first controller for checking whether a packet is received successfully, thus obtaining a correct packet,
a second controller for checking if the received packet comprises an indicator that the packet is a retransmitted packet, and if this is the case, combining the retransmitted packet with a previously received packet, thus obtaining a combined packet, and checking whether the combined packet is a correct packet,
a transmitter for sending a correct packet further to another base station.

12. The base station of claim 11, further comprising a transmitter configured to send a message to another base station when a packet was received from the uplink direction unsuccessfully.

13. A base station in a telecommunication system, comprising:
means for receiving uplink packet transmission,
means for checking whether a packet is received successfully, thus obtaining a correct packet,
means for checking if the received packet comprises an indicator that the packet is a retransmitted packet, and if this is the case, combining the retransmitted packet with a previously received packet, thus obtaining a combined packet, and
checking whether the combined packet is a correct packet, and
means for sending a correct packet further to another base station.

14. A telecommunication system, comprising a plurality of base stations and at least one mobile station utilising a packet mode transmission,
a first base station being configured to send downlink packet transmission to a mobile station,
the first base station and at least one other base station being configured to receive uplink packet transmission of a mobile station and to check whether a packet is received successfully from the mobile station,
the at least one other base station being configured to send a received packet to the first base station, if the at least one other base station received the packet successfully,
and, if the first base station received a packet successfully from the mobile station, the first base station is configured to send a received packet further to other parts of the telecommunication system,
and, if the first base station received a packet unsuccessfully from the mobile station, the first base station is configured to combine the packet received from the mobile station with the at least one packet received from the at least one other base station, thus obtaining a combined packet, and to send the combined packet further to other parts of the telecommunication system.

15. The system of claim 14, wherein the at least one other base station is configured to send a message to the first base station when a packet was received from the mobile station unsuccessfully.

16. The system of claim 14, wherein the first base station is configured to send a retransmission request to the mobile station if both the first base station and the at least one other base station received a packet unsuccessfully.

17. The system of claim 14, wherein the first base station is configured to initialise a timer when a packet is received unsuccessfully from the mobile station, and send a retransmission request to the mobile station if a successfully received packet has not been received from at least one other base station within a predetermined time period.

18. The system of claim 16, wherein the mobile station is configured to resend a packet on the basis of the retransmission request, the resent packet comprising an indication that the transmission is a retransmission.

19. The system of claim 16, wherein the at least one other base station, receiving a retransmitted packet, is configured to
detect from the retransmission indication of the packet that the packet is a retransmitted packet,
combine the retransmitted packet with a previously received packet,
check if the combined packet is correct and
send the combined packet to the first base station if the combined packet is correct.

20. A mobile station of a telecommunication system comprising a plurality of base stations, the mobile station configured to
utilise a packet mode transmission; send a packet to at least one base station, receive a retransmission request from a base station, and
resend a packet on the basis of the retransmission request, the resent packet comprising an indication that the transmission is a retransmission.

21. A mobile station of a telecommunication system comprising a plurality of base stations, the mobile station configured to
utilise a packet mode transmission;
send a packet to uplink direction,
receive a retransmission request from downlink direction,
resend a packet on the basis of the retransmission request, the resent packet comprising an indication that the transmission is a retransmission.

22. A computer program distribution medium readable by a computer and encoding a computer program of instructions for executing a computer process for data transmission method in a telecommunication system, the process comprising:
transmitting a downlink packet transmission,
receiving uplink packet transmission,
checking whether a packet is received successfully, thus obtaining a correct packet,
receiving from at least one other base station, a packet the at least one other base station has successfully received from the uplink direction,
combining a packet unsuccessfully received from the uplink direction with the at least one packet received from the at least one other base station, and
sending a correct packet further to other parts of the telecommunication system.

23. The computer program distribution medium of claim 22, the distribution medium including at least one of the following media: a computer readable medium, a program storage medium, a record medium, a computer readable memory, a computer readable software distribution package, a computer readable signal, a computer readable telecommunications signal, and a computer readable compressed software package.
